(19) United States
(12) Patent Application Publication
(10) Pub. No.: US 2022/0356271 A1
(43) Pub. Date: Nov. 10, 2022

(54) PROCESS FOR HYDROPHOBIC MODIFICATION OF NANOCELLULOSE DURING MANUFACTURING

(71) Applicant: Essentium, Inc., Pflugerville, TX (US)

(72) Inventors: Nirup Nagabandi, Pflugerville, TX (US); Joseph Gerringer, Austin, TX (US); Kevin Michael Holder, Pflugerville, TX (US); Elisa Teipel, Pflugerville, TX (US)

(21) Appl. No.: 17/298,232

(22) PCT Filed: Nov. 26, 2019
(86) PCT No.: PCT/US2019/063275

§ 371 Date: May 28, 2021

Related U.S. Application Data
(60) Provisional application No. 62/773,649, filed on Nov. 30, 2018.

(51) Int. Cl. C08B 15/06; C08J 5/06; C08J 3/12

(52) U.S. Cl. CPC C08B 15/06; C08J 5/06; C08J 3/126; C08J 2300/00; C08J 2401/02

(57) ABSTRACT

Modified nanocellulose particle include a nanocellulose particle, a binder coating the particle, and an alkyl amine affixed to the binder coating. A method of modifying nanocellulose particles includes adding a binder and a hydrophobizing agent to a slurry of nanocellulose particles in water, modifying the nanocellulose particles with the binder and hydrophobizing agent, and collecting the modified nanocellulose particles.

### CROSS REFERENCE TO RELATED APPLICATIONS

The present application claims the benefit of U.S. provisional application No. 62/773,649, filed on Nov. 30, 2018; the disclosure of which is incorporated herein by reference in its entirety.

### FIELD

The present disclosure is directed to a process for the hydrophobic modification of nanocellulose during manufacturing.

### BACKGROUND

The statements in this section merely provide background information related to the present disclosure and may or may not constitute prior art.

Composites include multiple materials, which are preferably combined to synergistically yield improved properties over the starting materials. Nano-composites, in particular, are formulated with nanoparticles, particles generally having at least one dimension less than 1,000 nanometers in size, dispersed in a matrix material. Nanoparticles of a given material may possess mechanical, thermal, electrical, and optical properties, as well as other properties, that differ from the bulk material of the nanoparticle material due to the increased surface area per unit volume of the nanoparticles compared to the bulk material. Accordingly, nanoparticle additions of less than 5 weight percent may be sufficient to alter the properties of the matrix material.

One such nanoparticle is nanocellulose. Nanocellulose is available, for example, in the form of cellulose nanocrystals and cellulose nanofibers. Nanocellulose particles are considered a viable candidate for reinforcing material given its relatively high specific strength, relatively low density, and abundance in nature. Table 1 provides a comparison of cellulose nanocrystal properties with other reinforcing materials including aluminum, glass, steel, forms of carbon, and poly(paraphenylene terephthalamide) commonly referred by the tradename KEVLAR.

TABLE 1
PROPERTIES OF VARIOUS REINFORCING MATERIALS

| Material | ρ/(g cm⁻³) | σ_{f} (GPa) | E_{A} (GPa) | E_{T} (GPa) |
|---|---|---|---|---|
| Kevlar-49 fiber | 1.4 | 3.5 | 124-130 | 2.5 |
| Carbon fiber | 1.8 | 1.5-5.5 | 150-500 | |
| Steel wire | 7.8 | 4.1 | 210 | |
| Clay nanoplatelets | | | 170 | |
| Carbon nanotubes | | 11-63 | 270-950 | 0.8-30 |
| Boron nanowhiskers | | 2-8 | 250-360 | |
| Crystalline cellulose | 1.6 | 7.5-7.7 | 110-220 | 10-50 |

ρ = Density,
σ_{f} = Tensile Strength,
E_{A} = Elastic Modulus in axial direction,
E_{T} = Elastic modulus in transverse direction

While nanocellulose has a relatively low energy of preparation compared to, for example, aluminum, glass, steel, carbon and other nano-reinforcements, it is often available in slurry form. Many manufacturing processes, including extrusion and molding, however, are not readily suitable for wet processes and the processes may not be easily or cheaply used with liquid dispersions of the nanocellulose. Further, bulk transportation of nanocellulose in water may be relatively less economic than solid, powder form.

On the other hand, drying methods to provide the nanocellulose in powder form, such as spray drying, freeze drying, or other drying methods may lead to the formation of nanocellulose aggregates of nano-scale (measuring 500 nanometers to 1,000 nanometers) in size and micro-scale (measuring 1 micrometer to 100 micrometers) in size. These aggregates, due in part to surface forces and hydrogen bonding, are difficult to mechanically break-up once formed, making it difficult to achieve a nano-dispersion.

In addition to the above, a number of polymer matrices are relatively hydrophobic in nature. The hydrophobic nature of such polymer matrices increases the difficulty in dispersing nanocellulose in the matrices. The reduction in dispersibility, due to the formation of aggregates, the hydrophobic nature of some matrices, or both in conjunction may reduce the effectiveness of nanocellulose additions.

Thus, while nanocellulose dispersions may achieve their intended purpose to an extent, there is a need for a new and improved process of providing nanoparticles, and particularly of providing modified nanocellulose particles. The modified nanocellulose particles may improve the dispersibility of nanocellulose in hydrophobic matrices, in turn resulting in an improvement in nanocomposite properties.

### SUMMARY

According to several aspects, the present disclosure relates to a method of hydrophobically modifying nanocellulose particles. The method includes adding a binder and a hydrophobizing agent to a slurry of nanocellulose particles in water and modifying the nanocellulose particles with the binder and the hydrophobizing agent. The method also includes adjusting a pH of the slurry to a pH in the range of 7.5 to 9. The method further includes collecting the modified nanocellulose particles.

In an additional aspect, the nanocellulose particles are present in the slurry in the range of 0.5 percent by weight solids to 15 percent by weight solids.

In another additional aspect, the hydrophobizing agent is alkyl amine.

In a further additional aspect, the alkyl amine is added to the slurry in an amount in the range of 0.5 to 5 times the weight of the nanocellulose.

In yet a further additional aspect, the alkyl amine is represented by the following formula: CH₃—(CH₂)ₙ—NH₂, wherein n is in the range of 0 to 19.

In yet a further additional aspect, the alkyl amine is dodecyl amine.

In yet a further additional aspect, the alkyl amine is hexadecyl amine.

In yet a further additional aspect, the binder is added to the slurry in an amount in the range of 1% to 10% by weight of the nanocellulose solids.

In yet a further additional aspect, the binder forms a coating around the nanocellulose particles.

In yet a further additional aspect, the hydrophobizing agent is affixed to the binder coating on the nanocellulose particle.

In yet a further additional aspect, the binder is selected from a polyphenol, a polydopamine, or a combination thereof.

In yet a further additional aspect, the modified nanocellulose particles are collected by washing and filtering the modified nanocellulose particles.

In yet a further additional aspect, the modified nanocellulose particles are dried at a temperature in the range of 20° C. to 120° C. for a time period in the range of 1 hour to 24 hours.

According to several aspects, the present disclosure relates to a modified nanocellulose particle including a nanocellulose particle, a binder coating the particle, and a hydrophobizing agent affixed to the binder coating.

In an additional aspect, the hydrophobizing agent is alkyl amine.

In a further additional aspect, the alkyl amine is represented by the following formula: CH₃—(CH₂)ₙ—NH₂, wherein n is in the range of 1 to 19.

In yet a further additional aspect, the alkyl amine is dodecyl amine.

In yet a further additional aspect, the alkyl amine is hexadecyl amine.

In yet a further additional aspect, the binder is tannic acid.

According to several aspects, the present disclosure relates to a method of manufacturing a composite. The method includes combining a modified nanocellulose particle and a matrix material. The modified nanocellulose particle includes a nanocellulose particle, a binder coating the particle, and an alkyl amine extending from the binder coating.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1A is an illustration of forming a nanocomposite including dried, unmodified nanocellulose particles;

FIG. 1B is an illustration of forming a nanocomposite including modified nanocellulose particles according to an exemplary embodiment;

FIG. 2 is a flowchart of a method of modifying nanocellulose particles according to an exemplary embodiment;

FIG. 3 is an illustration of a modified nanocellulose particle according to an exemplary embodiment;

FIG. 4 is a graph of the effect of nanocellulose particle concentration and alkyl amine selection on yield according to an exemplary embodiment;

FIG. 5 is a graph of the effect of alkyl amine to nanocellulose particle weight ratio on the yield of the nanocellulose particles according to an exemplary embodiment;

FIG. 6 is a graph of the effect of alkyl amine concentration, binder and buffer concentration (all parameters), and washing step on the yield of the modified nanocellulose particles according to exemplary embodiments; and

FIG. 7 is a scanning electron microscope micrograph of the modified nanocellulose particles, in the form of fibers, according to an exemplary embodiment, the micrograph scale (shown in the lower right hand corner) is 1 micrometer.

### DETAILED DESCRIPTION

The following description is merely exemplary in nature and is not intended to limit the present disclosure, application, or uses.

As alluded to above, composites are understood to be a combination of materials created to synergistically deliver improved properties not exhibited by the individual materials. Such properties may include, but are not limited to, thermal, mechanical, electrical, and optical properties. Nanocomposites are understood herein to include nanoparticles dispersed in a matrix material. Nanoparticles are understood as particles have a size in at least one dimension of less than 1,000 nm. Further, in nanodispersions, it is understood that nanoparticles are dispersed in a nanocomposite and exhibit nanoparticle phases (i.e., aggregates of nanoparticles) less than 1,000 nm in size in the matrix.

One such nanoparticle is nanocellulose. Nanocellulose particles are understood to exhibit properties comparable, and in some cases, superior to other reinforcing materials as noted in Table 1 above. In aspects, nanocellulose particles are available as cellulose nanocrystals and cellulose nanofibers. The relatively high surface area of nanocellulose particles (for example, on the order of 20 meters squared per gram to 50 meters squared per gram measured by the BET method) may allow for relatively low volumetric loading of the nanoparticles in a composite matrix to achieve desirable properties. In aspects, the loading of these nanoparticles is less than 30% by weight of the total weight of the composite, including all values and ranges from 0.1 to 30% by weight, such as less than 10% by weight, less than 5% by weight, etc.

When presented in dry form rather than in slurry, nanocellulose particles may form aggregates. Aggregates of the nanocellulose particles reduce the loading efficiency and effectiveness of the nanocellulose particles in a composite. On the other hand, it is difficult to dry process or melt process nanocellulose particles when provided in slurry. It is noted that dry processes or melt processes include, for example, blending, injection molding, casting, or extrusion. Further, slurries may not be as economical to transport as dry particles.

While not being bound to a particular theory, the nanocellulose particles are understood to aggregate due to the relatively high surface energy of the particles; as aggregation is understood to reduce the surface energy. Aggregation is understood to be fostered by attractive forces between the nanoparticles including hydrophilic, polar bonding, and dipole attractive forces.

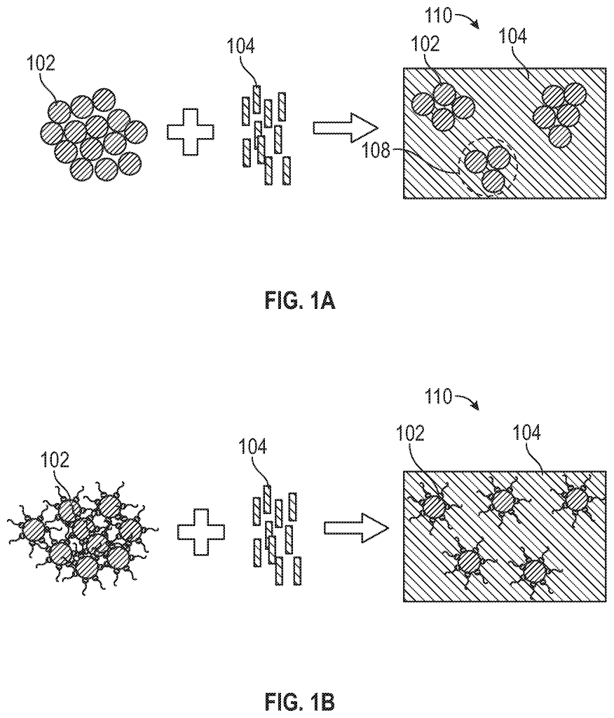

Regardless, the nanoparticle aggregates are difficult to mechanically break down in manufacturing. As illustrated in FIG. 1A, when adding nanoparticles 102 to matrix materials 104, in this case polymer pellets, during dry or melt-processing techniques, a relatively large portion of the nanoparticles 102 become dispersed in the matrix material 104 as aggregates 108 to form a composite 110. Further, due to the hydrophilic nature of nanocellulose particles, the nanoparticles do not disperse well in relatively hydrophobic matrix material, such as olefins, fluoropolymers, polyamides, polyisobutylene, and silicones. In non-limiting examples, the water contact angles of some polymers are on the order of 70 degrees or greater measured in air, such as in the range of 70 degrees to 130 degrees measured in air, 90 degrees to 130 degrees, etc. As illustrated in FIG. 1B, modifying the nanoparticles 102 to increase hydrophobicity allows easier mechanical breakage of aggregates and, when added to the matrix materials 104, provides improved dispersion of the particles in the matrix material 104 to form a composite 110.

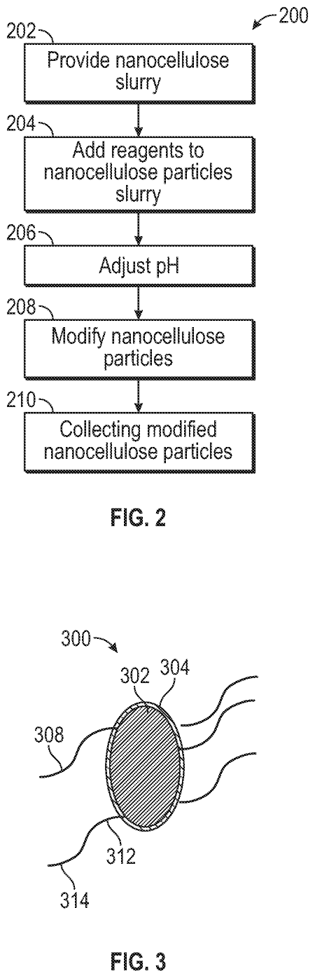

A method of modifying nanocellulose particles to increase particle hydrophobicity is illustrated in FIG. 2. In aspects, the method 200 begins with a slurry 202 of nanocellulose particles in water. In aspects, the nanocellulose particles are present in the slurry in the range of 0.5 percent by weight solids to 15 percent by weight solids, including all values and ranges therein, such as in the range of 1 percent by weight solids to 2.5 percent by weight solids, 1 percent to 4.5 percent by weight solids, etc. That is, the nanocellulose particles are present in the range of 0.5 to 15 percent of the total composition weight of the water and nanocellulose particles, including all values and ranges therein, such as in the range of 1 percent by weight to 2.5 percent by weight of the slurry including the particles, 1 percent by weight to 4.5 percent by weight solids, etc.

In aspects, the nanocellulose particles include particles having a particle size or a diameter of less than 1,000 nm. In some aspects, the particles have a particle size range of 1 nm to 500 nm, including all values and ranges therein, such as in the range of 150 nm to 200 nm. In aspects, the nanocellulose particles are provided as nanocrystals exhibiting aspect ratios (the ratio of the length to the width of the particles) in the range of 7.1:1 to 40:1, including all values and ranges therein, wherein the length is understood as the particle size. In aspects where the nanocellulose is provided as a fiber, the diameter of the fiber may be in the range of 1 nm to 500 nm, including all values and ranges therein; however, the fibers may be up to 500 micrometers long. In some aspects, the nanocellulose particles include sulfuric acid hydrolyzed nanocellulose particles, carboxylated nanocellulose particles, lignin-coated nanocellulose particles or combinations thereof.

Referring again to FIG. 2, a hydrophobizing agent and a binder are added to the slurry 202. The hydrophobizing agent is understood to increase the hydrophobicity of the nanocellulose particles. In some aspects, the hydrophobizing agent includes a relatively more polar group at one end and a relatively less polar group at the other end. In alternative or additional aspects, the hydrophobizing agent may include other configurations such as, but not limited to, two polar heads present at either end of the chain or a non-polar head present in the middle of the chain. In some aspects, the hydrophobizing agent includes alkyl amine. In aspects, alkyl amine is added to the slurry in an amount in the range of 0.5 to 5 times the weight of the nanocellulose, wherein the ratio of the alkyl amine to the nanocellulose is in the range of 0.5:1 to 5:1 by weight, including all values and ranges therein.

The alkyl amine may be linear or branched having in the range of 1 to 20 carbons, including all values and ranges therein. Further, the alkyl amine may include one or more amine groups at the terminal ends or extending form the middle of the chain. In yet further aspects, the alkyl is linear and includes 1 to 20 carbons. In yet further aspects, the alkyl amine is represented by the following formula:

CH₃—(CH₂)ₙ—NH₂,

wherein n is in the range of 0 to 19, including all values and ranges therein, such as in some aspects in the range of 1 to 19, in the range of 10 to 15, 12, 14 or 15. In one aspect, the alkyl amine is dodecyl amine. In another aspect, the alkyl amine is hexadecyl amine. In a further aspect, the alkyl amine is a combination of the alkyl amines noted herein.

Binders are understood herein as compounds that affix the hydrophobizing agent to the nanocellulose particles. In aspects, the bonding between the binder and the hydrophobizing agent is covalent. Further depending on the binder, the binder may bond with the nanocellulose particle through, e.g., covalent bonding, hydrogen bonding, chelation, or π−π interactions. In aspects, the binder is added to the slurry in an amount in the range of 1% to 10% by weight of the nanocellulose solids weight, including all values and ranges therein. It may be appreciated that the binder may be added before, with, or after the addition of the hydrophobizing agent. The binder forms a coating on the surface of the nanocellulose particles. In aspects, binders include, but are not limited to, polyphenols, polydopamines or combinations thereof, such as plant polyphenols and polydopamines. In further aspects, the binders are selected from one or more of phenolic acids, flavonoids, stilbenes and lignans. In some aspects, tannic acid is used.

In aspects, illustrated in FIG. 2, the pH of the slurry is adjusted to a pH in the range of 7.5 to 9, and in aspects, from 7.8 to 8.4 through the addition of buffers 206. In aspects, buffers are added in amounts in the range of 1% to 10% by weight to weight of nanocellulose solids, including all values and ranges therein, to adjust the pH of the slurry. The buffers may be added at the same time the hydrophobizing agent and binder or added or after the hydrophobizing agent and binder is added. Further, in aspects, the buffers may include, but are not limited to (4-(2-hydroxyethyl)-1-piperazineethanesulfonic acid) (HEPES) buffer, ethylene glycol tetra acetic acid (EGTA) buffer, phosphate buffers, phenylmethane sulfonyl fluoride or phenylmethylsulfonyl fluoride (PMSF) buffer, ethylenediaminetetraacetic acid (EDTA) buffer and combinations thereof.

In aspects, the slurry is agitated, causing interactions between the nanocellulose particles with the binder and hydrophobizing agent. The nanocellulose particles are modified with the binder and hydrophobizing agent 208. After modification, the nanocellulose particles are then collected 210.

In aspects, the modified nanocellulose particles are collected by washing the nanocellulose particles, such as by washing in water at 1 to 100 times the weight of the solids and then passing the solution through a 1 micrometer filter as more water is added on the filter paper. In aspects, during washing the modified nanocellulose particles are filtered using filter paper and, in further aspects, the top is collected. The particles may also be collected via centrifuge. In aspects, the modified nanocellulose particles are dried by air or by oven drying at temperatures in the range of 20 degrees C. to 120 degrees C., including all values and ranges there in, such as 80 degrees C., for a period of time in the range of 1 hour to 24 hours including all values and increments therein, such as 8 hours to 15 hours.

An aspect of the modified nanocellulose particles provided herein is illustrated in FIG. 3. The modified nanocellulose particle 300 includes a nanocellulose particle 302 at its core. The binder 304, as described herein, is present as a coating on the surfaces 306 of the nanocellulose particle 302. The hydrophobizing agent 308, also as described herein, is affixed to the binder 304. In aspects, one end 312 of the hydrophobizing agent 308, such as the relatively polar amine group, may attach to the binder and the other end 314 of the hydrophobizing agent 308, the relatively less polar alkyl group, may extend into the slurry. However, alternative or additional orientations of the hydrophobizing agent may be assumed. In aspects, the water contact angles of the modified nanocellulose particles may be in the range of 70 to 130, including all values and ranges therein. It is noted that there may be variation in the range, i.e., not all of the particles may exhibit the same hydrophobicity. It is also noted that unmodified nanocellulose particles may exhibit relatively lower water contact angles, such as in the range of 15 to 25, including all values and ranges therein, as measured in air.

In aspects, the modified nanocellulose particles are combined with a matrix material. In some aspects, the matrix material is a polymer material, such as a thermoplastic or thermoset polymer including, but not limited to, polyolefins such as polyethylene or polypropylene, fluoropolymers, or silicones polymers. The modified nanocellulose particles and polymer materials may then be dry or melt-processed using techniques such as dry-blending, melt-blending, injection molding, extrusion or casting, to provide a nanocomposite article, wherein a nano-dispersion of the nanocellulose is exhibited. In aspects, the modified nanocellulose particles may be present in the matrix material in a range of 0.01 to 30 percent by weight of the total composite, including all values and ranges therein, such as in the range of 0.01 to 10 percent by weight, 0.01 to 5.0 percent by weight, etc.

### EXAMPLES

Specimens of nanocellulose particles in slurry were obtained from the University of Maine and Aloterra. The concentrations of nanocellulose particles in the slurry, i.e., water, of the various specimens included: 0.5%, 1%, 1.5%, 2% 2.5%, and 3% percent solids in the slurry. A number of samples were then prepared from the specimens by adding varying amounts of dodecyl amine and hexadecyl amine.

In addition, tannic acid added to the samples in amounts of 5% by weight of the nanocellulose solids. A HEPES buffer was also added to the slurry in an amount of 5% by weight of the nanocellulose solids. After modification, it was observed that the nanocellulose particles floated to the surface of the samples indicating the hydrophobic nature of the particles. The modified nanocellulose particles were found to be hydrophobically enhanced, exhibiting water contact angles in the range of 70 to 130, as measured in air.

The modified nanocellulose particles were then washed, dried and collected. In washing, 100 times the all solids weight of water is added to the particles and the solution is vigorously shaken. The solution is then passed through 1 micron filter paper under vacuum while adding another 100 times the all solids weight of water. The top portion from the filter paper is collected and dried in oven at 80° C. The collected particles were then added to hexane, a non-polar solvent, in the amount of 0.02 g per 5 mL of solvent. It was observed that the nanocellulose particles were completely soluble in the non-polar solvent, indicating that the modified nanocellulose particles would be dispersible in polymer materials such as polypropylene.

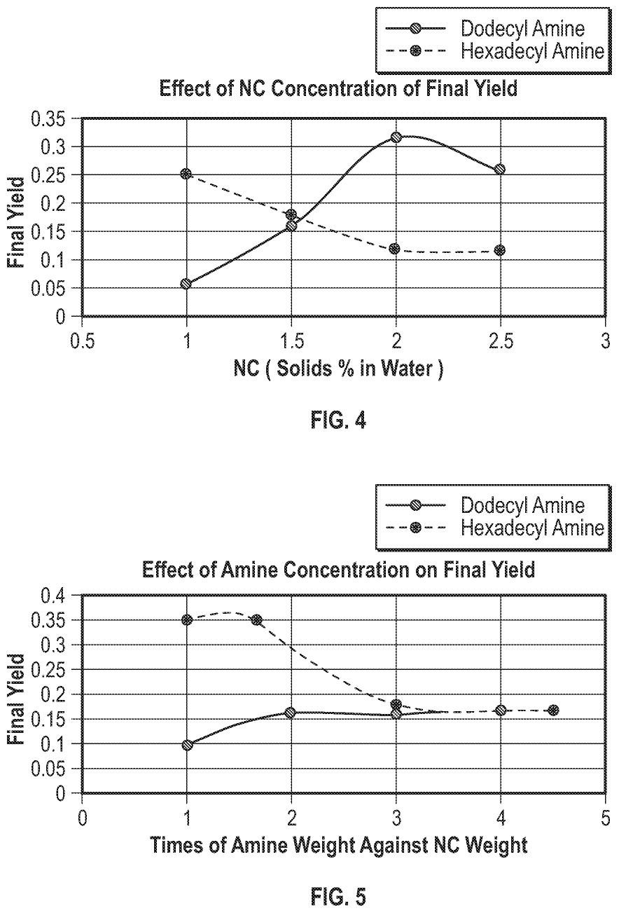

Improvements on yield were observed by adjusting the concentrations of the nanoparticles and hydrophobizing agent. FIG. 4 illustrates the effect of dodecyl amine and hexadecyl amine on the final yield for varying percent solids of the nanocellulose particles in the slurry. In this graph, 2 times the nanocellulose weight in dodecyl amine was added to sample slurries of varying nanocellulose (NC) concentrations and 3 times the nanocellulose weight (NC weight) in hexadecyl amine was added to the sample slurries of varying nanocellulose concentrations. As illustrated, the yield of a given alkyl amine is affected by the percent solids in the slurry of the nanocellulose particles. FIG. 5 illustrates the effect on final yield of the weight ratio of dodecyl amine and hexadecyl amine to the nanocellulose particles in the slurry, wherein the nanocellulose particles were present at 1.5 wt. % solids in the sample slurries. As illustrated, increasing dodecyl amine and hexadecyl amine additions approaching four times the weight of the nanocellulose particles provides diminishing improvements. Overall, hexadecyl amine yielded 35% at lower concentrations of nanocellulose particles and at lower alkyl amine to nanocellulose particle ratios. For dodecyl amine, a 32% yield was observed at high concentrations of nanocellulose and medium weight ratios of amine to nanocellulose particles present in the slurry.

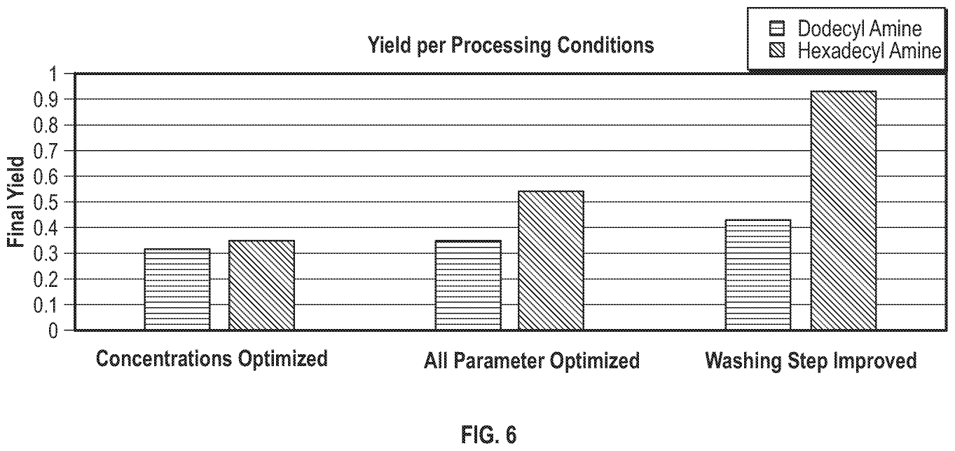

FIG. 6 summarizes the effect of the hydrophobizing agent on yield of the nanocellulose particles, which were initially present in the slurry at 1.5 wt. % percent solids for each alkyl amine examined. The graph illustrates hexadecyl amine present at a weight ratio of 2.5:1 and dodecyl amine present at a weight ratio of 2:1. The hexadecyl amine provided a yield of 35% and the dodecyl amine provided a yield of 38% (Binder and buffer present were in amounts of 2 wt. % and 3 wt. %, respectively, of nanocellulose solids weight).

Then, the binder and the buffer concentrations were adjusted. FIG. 6 illustrates that, in adjusting tannic acid concentration, and buffer concentration, yields of 54% and 35% were observed for hexadecyl amine and dodecyl amine, respectively (at same modified nanocellulose and amine concentrations), binder and buffer were adjusted to 5% and 5%, respectively).

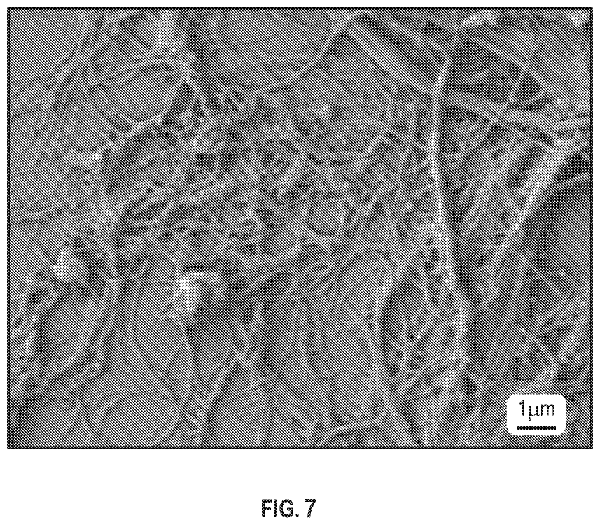

FIG. 6 further illustrates that in altering the washing step, including filtration, yields of 93% to 43% were observed for hexadecyl amine and dodecyl amine, respectively. Washing was initially performed via centrifuge at 3,000 rpm to remove unreacted amine from the modified nanocellulose suspension. It was observed that amine floated even after 30 minute centrifuge at 3000 rpm due to its hydrophobicity. The top was discarded and the bottom was collected and dried in oven at 80° C. overnight. Washing was then performed with filtration instead of separating the nanocellulose particles and amine via centrifuge. In filtration, excess water was used to wash away the amine and a 1 micron pore size filter was used to filter the amine particles under vacuum. This material was collected and dried in oven at 80° C. overnight. FIG. 7 illustrates the nanocellulose functionalized with tannic acid and an alkyl amine after drying with minimal agitation.

While optimization is discussed above in terms of yield, other factors may alternatively, or additionally, be considered. For example, situations may arise where material selection, e.g., the selection of hydrophobizing agent, binder and buffer, are more critical than yield. Thus, the “optimized” results discussed herein are for purposes of explanation and other variations are contemplated herein.

The method and modified nanocellulose particles of the present disclosure offer several advantages. These include providing a “drop-in” technology in nanocellulose manufacturing, wherein the modified nanocellulose particle aggregates may be broken apart during composite formation. These also include providing dispersible nanoparticles, which are capable of forming nano-dispersions within the nanocomposite matrix materials, even for those materials that exhibit a relatively high degree of hydrophobicity including, but not limited to, matrix materials with water contact angles in the range of 70 to 130 degrees, as measured in air, such as polypropylene, polyamides, and polyisobutylene, among others.

The description of the present disclosure is merely exemplary in nature and variations that do not depart from the gist of the present disclosure are intended to be within the scope of the present disclosure. Such variations are not to be regarded as a departure from the spirit and scope of the present disclosure.

1. A method of modifying nanocellulose particles, comprising:
adding a binder and a hydrophobizing agent to a slurry of nanocellulose particles in water;
adjusting a pH of the slurry to a pH in the range of 7.5 to 9;
modifying the nanocellulose particles with the binder and hydrophobizing agent; and
collecting the modified nanocellulose particles, wherein the modified nanocellulose particles exhibit a water contact angle, measured in air, in the range of 70 to 130 degrees.

2. The method of claim 1, wherein nanocellulose particles are present in the slurry in the range of 0.5 percent by weight solids to 15 percent by weight solids.

3. The method of claim 1, wherein the hydrophobizing agent is alkyl amine.

4. The method of claim 3, wherein the alkyl amine is added to the slurry in an amount in the range of 0.5 to 5 times the weight of the nanocellulose.

5. The method of claim 4, wherein the alkyl amine is represented by the following formula:
CH3—(CH2)n—NH2,
wherein n is in the range of 0 to 19.

6. The method of claim 4, wherein the alkyl amine is dodecyl amine.

7. The method of claim 4, wherein the alkyl amine is hexadecyl amine.

8. The method of claim 1, wherein the binder is added to the slurry in an amount in the range of 1% to 10% by weight of the nanocellulose solids.

9. The method of claim 1, wherein the binder forms a coating around the nanocellulose particles.

10. The method of claim 9, wherein the hydrophobizing agent is affixed to the binder coating on the nanocellulose particle.

11. The method of claim 1, wherein the binder is selected from a polyphenol, a polydopamine, or a combination thereof.

12. The method of claim 1, wherein the modified nanocellulose particles are collected by washing and filtering the modified nanocellulose particles.

13. The method of claim 1, wherein the collected, modified nanocellulose particles are dried at a temperature in the range of 20° C. to 120° C. for a time period in the range of 1 hour to 24 hours.

14. A modified nanocellulose particle, comprising:
a nanocellulose particle;
a binder coating the particle; and
a hydrophobizing agent affixed to the binder coating,
wherein the modified nanocellulose particle exhibit a water contact angle, measured in air, in the range of 70 to 130 and the modified nanocellulose particle is combined with a polymer matrix material exhibiting a water contact angle, measured in air, in the range of 70 to 130 degrees.

15. The modified nanocellulose particle of claim 14, wherein the hydrophobizing agent is alkyl amine.

16. The modified nanocellulose particle of claim 15, wherein the alkyl amine is represented by the following formula:
CH3—(CH2)n—NH2,
wherein n is in the range of 0 to 19.

17. The modified nanocellulose particle of claim 15, wherein the alkyl amine is selected from dodecyl amine, hexadecyl amine, or combinations thereof.

18. The modified nanocellulose particle of claim 15, wherein the binder is selected from a polyphenol, a polydopamine or a combination thereof.

19. The modified nanocellulose particle of claim 14, wherein the binder is tannic acid.

20. A method of manufacturing a composite, comprising:
combining a modified nanocellulose particle having a water contact angle, measured in air, in the range of 70 to 130 degrees, and a polymer matrix material having a water contact angle, measured in air, in the range of 70 to 130 degrees, wherein the modified nanocellulose particle includes
a nanocellulose particle,
a binder coating the particle; and
an alkyl amine affixed to the binder coating.
